(19) United States
(12) Patent Application Publication
(10) Pub. No.: US 2014/0266148 A1
(43) Pub. Date: Sep. 18, 2014

(54) COIN-LEVEL DETERMINATION SYSTEM FOR COIN BOX

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: PENG ZHANG, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/973,738

(22) Filed: Aug. 22, 2013

(30) Foreign Application Priority Data
Mar. 12, 2013 (CN) 2013100777843

(51) Int. Cl. G01N 27/04

(52) U.S. Cl. CPC G01N 27/04
USPC 324/71.1

(57) ABSTRACT

A system for detecting the level of coins in a coin box of a vending machine includes a voltage output circuit, a coin detecting circuit, and an indication circuit. The voltage output circuit receives a DC voltage, and provides a stable reference voltage. The coin detecting circuit receives the stable reference voltage, and detects the resistance of the coins in the coin box on the basis that the aggregate of accumulated coins creates an electrical connection across the coin box in parallel with known-value resistors in the coin detecting circuit. An amplification of the reference voltage takes place and the indication circuit receives the amplified reference voltage, to indicate by display or otherwise that the coin box is filled with coins or is not yet filled with coins.

### BACKGROUND

1. Technical Field

The present disclosure relates to a system to detect the level of coins in the coin boxes of vending machines.

2. Description of Related Art

Vending machines include coin boxes for receiving and accommodating coins. Typical vending machines cannot detect coins in the coin boxes. When the coin boxes are filled with coins, the coins may not be accepted by the coin boxes resulting the coin boxes to malfunction.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a coin-detecting system for a coin box.

FIG. 2 is a circuit diagram of the coin-detecting system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a coin-detecting system for detecting the number of coins in a coin box (coin box M) which includes a voltage output circuit 100, a coin detecting circuit 200, and an indication circuit 300.

FIG. 2 shows the voltage output circuit 100 which includes a first amplifier U1, a first variable resistor VR1, a first resistor R1, a second resistor R2, and a Zener diode VZ. The first amplifier U1 includes a non-inverting input terminal, an inverting input terminal and an output terminal. The first variable resistor VR1 includes a first terminal, a second terminal, and an adjusting terminal A first terminal of the first resistor R1 is electrically connected to a positive terminal +VCC. A second terminal of the first resistor R1 is electrically connected to a cathode of the Zener diode VZ. An anode of the Zener diode VZ is grounded. The first terminal of the first variable resistor VR1 is electrically connected to the second terminal of the first resistor R1. The second terminal of the first variable resistor VR1 is grounded. The adjusting terminal of the first variable resistor VR1 is electrically connected to the non-inverting input terminal of the first amplifier U1 via the second resistor R2. The inverting input terminal of the first amplifier U1 is electrically connected to the output terminal of the first amplifier U1.

The coin detecting circuit 200 includes a second amplifier U2, a single-pole multi-throw (SPMT) switch S, a third resistor R3, and a selection resistors R5-R10. The second amplifier U2 includes a non-inverting input terminal, an inverting input terminal and an output terminal. The SPMT switch S includes a connection terminal and a plurality of selection terminals. The plurality of selection terminals of the SPMT switch S are electrically connected to first terminals of the selection resistors R5-R10. Second terminals of the selection resistors R5-R10 are electrically connected to the output terminals of the first amplifier U1. The connection terminal of the SPMT switch S is electrically connected to the inverting input terminal of the second amplifier U2. The SPMT switch S is switched to select a first selection resistor of the selection resistors R5-R10 by connecting the connection terminal and one of the plurality of selection terminals together. The non-inverting input terminal of the second amplifier U2 is electrically connected to a negative terminal −VCC via the third resistor R3. The inverting input terminal and the output terminal of the second amplifier U2 are electrically connected to two ends of the coin box M. In one embodiment, the respective resistances of the selection resistors R5-R10 gradually decrease from R5 to R10. A voltage on the positive terminal +VCC and the negative terminal −VCC is +9V. A current flowing through the positive terminal +VCC and the negative terminal −VCC is 12 mA.

The indication circuit 300 includes a micro ampere meter P, a second variable resistor VR2, and a fourth resistor R4. The second variable resistor VR2 includes a first terminal, a second terminal, and an adjusting terminal. A first terminal of the fourth resistor R4 is electrically connected to the output terminal of the second amplifier U2. A second terminal of the fourth resistor R4 is electrically connected to the first terminal of the second variable resistor VR2 via the micro ampere meter P. The second terminal of the second variable resistor VR2 is grounded. The adjusting terminal of the second variable resistor VR2 is electrically connected to the second terminal of the second variable resistor VR2.

In operation, the +9V DC voltage is divided by the first resistor R1 and the first variable resistor VR1, and stabilized by the Zener diode VZ to generate a reference voltage. The first amplifier U1 receives the reference voltage and outputs a stable reference voltage. A relationship between an output voltage V1 of the first amplifier U1 and an output voltage V2 of the second amplifier U2 can be calculated by the following formula: V2/V1=Rm/Rx. In one embodiment, Rm is an overall resistance of the coin box M, and Rx is a resistance of one of the selection resistors R5-R10. A value of the current displayed on the micro ampere meter P is the quantity of current passing through the fourth resistor R4 and the second variable resistor VR2. The value of the current displayed on the micro ampere meter P is proportional to the output voltage V2 of the second amplifier U2. When coins are dropped into the coin box M, the coins are electrically connected in parallel with the coin box M. Thus the overall resistance of the coin box M decreases as a number of the coins put into the coin box M increases.

According to the above formula, the output voltage V2 of the second amplifier U2 is proportional to the resistance of the coin box M, and the output voltage V2 of the second amplifier U2 is inversely proportional to the resistance of one of the selection resistors R5-R10. When the coin box M is completely filled with coins, the resistance of the coin box M has a minimum value, and the output voltage V2 of the second amplifier U2 has a minimum value when the resistance of one of the selection resistors R5-R10 is fixed. Therefore, the value of the current displayed on the micro ampere meter P also has a minimum value.

When the coin box M is not filled with coins, the overall resistance of the coin box M is greater than the minimum value of the resistance Rm, and the output voltage V2 of the second amplifier U2 is greater than the minimum value of the output voltage V2 when the resistance of one of the selection resistors R5-R10 is fixed. Therefore, the value of the current displayed on the micro ampere meter P is greater than the minimum value of the current value. The value of the current displayed on the micro ampere meter P thus indicates whether the coin box M is filled with coins or not filled with coins.

In one embodiment, the SPMT switch S can select one of the selection resistors R5-R10 according to a manufactured volume of the coin box M. When the manufactured volume of the coin box M increases, the coin box M can be filled with more coins, and the resistance Rm of the coin box M is smaller than the minimum value of the resistance. The output voltage V2 of the second amplifier U2 is smaller than the minimum value of the output voltage V2. Therefore, the value of the current displayed on the micro ampere meter P is smaller than the minimum value of the current value, and the value of the current will not be displayed on the micro ampere meter P. The SPMT switch S is switchable to select a second selection resistor of the selection resistors R5-R10 which having a resistance smaller than a resistance of the first selection resistor. The resistance Rx of the second selection resistor is merely decreased to increase the output voltage V2 of the second amplifier U2 and the value of the current displayed on the micro ampere meter P. Therefore, the value of the current being displayed on the micro ampere meter P, to indicate that the coin box M is full, can be adjusted to suit different manufactured sizes of coin box. Similarly, when the manufactured volume of the coin box M decreases, the SPMT switch S is switched to select a third resistor of selection resistors R5-R10 having a resistance greater than the resistance of the first selection resistor.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A coin box detecting system for detecting a coin box, comprising:
a voltage output circuit adapted to receive a DC voltage, and divide the DC voltage to a stable reference voltage;
a coin detecting circuit adapted to receive the stable reference voltage and to detect a number of coins in the coin box, and output an amplified reference voltage according to the stable reference voltage and the number of coins in the coin box; and
an indication circuit adapted to receive the amplified reference voltage; and indicate whether the coin box is filled with coins according to the amplified reference voltage; wherein the indication circuit displays a minimum value of the amplified reference voltage to indicate that the coin box is filled with coins; and the indication circuit displays the amplified reference voltage greater than the minimum value to indicate that the coin box is not filled with coins.

2. The coin box detecting system of claim 1, wherein the voltage output circuit comprises a first amplifier, a first variable resistor, and a first resistor; the first amplifier comprises a non-inverting input terminal, an inverting input terminal and an output terminal; the first variable resistor comprises a first terminal, a second terminal, and an adjusting terminal; a first terminal of the first resistor is electrically connected to a positive terminal; a second terminal of the first resistor is electrically connected to the first terminal of the first variable resistor; the second terminal of the first variable resistor is grounded; the adjusting terminal of the first variable resistor is electrically connected to the non-inverting input terminal of the first amplifier; and the inverting input terminal of the first amplifier is electrically connected to the output terminal of the first amplifier.

3. The coin box detecting system of claim 2, wherein the voltage output circuit further comprises a Zener diode; a cathode of the Zener diode is electrically connected to the second terminal of the first resistor; and an anode of the Zener diode is grounded.

4. The coin box detecting system of claim 3, wherein the coin detecting circuit comprises a second amplifier, a single-pole multi-throw (SPMT) switch, and selection resistors; the second amplifier comprises a non-inverting input terminal, an inverting input terminal and an output terminal; the SPMT switch comprises a connection terminal and a plurality of selection terminals; the plurality of selection terminals of the SPMT switch are electrically connected to first terminals of the selection resistors; second terminals of the selection resistors are electrically connected to the output terminal of the first amplifier; the connection terminal of the SPMT switch is electrically connected to the inverting input terminal of the second amplifier; the non-inverting input terminal of the second amplifier is electrically connected to a negative terminal; and the inverting input terminal and the output terminal of the second amplifier are electrically connected to two ends of the coin box.

5. The coin box detecting system of claim 4, wherein a voltage on the positive terminal and the negative terminal is +9V.

6. The coin box detecting system of claim 4, wherein the output terminal of the first amplifier outputs the stable reference voltage; and the output terminal of the second amplifier outputs the amplified reference voltage.

7. The coin box detecting system of claim 4, wherein each of the of selection resistors has a different resistance; the SPMT switch is switched to select a first selection resistor of the selection resistors by connecting the connection terminal and one of the plurality of selection terminals together; the SPMT switch is adapted to select a second selection resistor of the selection resistors having a resistance smaller than a resistance of the first selection resistor when a volume of the coin box increases, and vice versa.

8. The coin box detecting system of claim 6, wherein the indication circuit comprises a micro ampere meter and a second variable resistor; the second variable resistor comprises a first terminal, a second terminal, and an adjusting terminal; the first terminal of the second variable resistor is electrically connected to the output terminal of the second amplifier via the micro ampere meter; the second terminal of the second variable resistor is grounded; and the adjusting terminal of the second variable resistor is electrically connected to the second terminal of the second variable resistor.

9. A coin box detecting system, comprising:
a coin box configured to accommodate a plurality of coins;
a voltage output circuit adapted to receive a DC voltage, and divide the DC voltage to a stable reference voltage;
a coin detecting circuit electrically connected to the coin box; the coin detecting circuit receives the stable reference voltage, detects a number of coins in the coin box, and outputs an amplified reference voltage according to the stable reference voltage and the number of coins in the coin box; and
an indication circuit adapted to receive the amplified reference voltage; and indicate whether the coin box is filled with coins according to the amplified reference voltage; wherein the indication circuit displays a minimum value of the amplified reference voltage to indicate that the coin box is filled with coins; and the indication circuit displays the amplified reference voltage greater than the minimum value to indicate that the coin box is not filled with coins.

10. The coin box detecting system of claim 9, wherein the voltage output circuit comprises a first amplifier, a first variable resistor, and a first resistor; the first amplifier comprises a non-inverting input terminal, an inverting input terminal and an output terminal; the first variable resistor comprises a first terminal, a second terminal, and an adjusting terminal; a first terminal of the first resistor is electrically connected to a positive terminal; a second terminal of the first resistor is electrically connected to the first terminal of the first variable resistor; the second terminal of the first variable resistor is grounded; the adjusting terminal of the first variable resistor is electrically connected to the non-inverting input terminal of the first amplifier; and the inverting input terminal of the first amplifier is electrically connected to the output terminal of the first amplifier.

11. The coin box detecting system of claim 10, wherein the voltage output circuit further comprises a Zener diode; a cathode of the Zener diode is electrically connected to the second terminal of the first resistor; and an anode of the Zener diode is grounded.

12. The coin box detecting system of claim 11, wherein the coin detecting circuit comprises a second amplifier, a single-pole multi-throw (SPMT) switch, and a selection resistors; the second amplifier comprises a non-inverting input terminal, an inverting input terminal and an output terminal; the SPMT switch comprises a connection terminal and a plurality of selection terminals; the plurality of selection terminals of the SPMT switch are electrically connected to first terminals of the selection resistors; second terminals of the selection resistors are electrically connected to the output terminal of the first amplifier; the connection terminal of the SPMT switch is electrically connected to the inverting input terminal of the second amplifier; the non-inverting input terminal of the second amplifier is electrically connected to a negative terminal; and the inverting input terminal and the output terminal of the second amplifier are electrically connected to two ends of the coin box.

13. The coin box detecting system of claim 12, wherein a voltage on the positive terminal and the negative terminal is +9V.

14. The coin box detecting system of claim 12, wherein the output terminal of the first amplifier outputs the stable reference voltage; and the output terminal of the second amplifier outputs the amplified reference voltage.

15. The coin box detecting system of claim 12, wherein each of the selection resistors has a different resistance; the SPMT switch is switched to select a first selection resistor of the selection resistors by connecting the connection terminal and one of the plurality of selection terminals together; the SPMT switch is adapted to select a second selection resistor of selection resistors having a resistance smaller than a resistance of the first selection resistor when a volume of the coin box increases; and vice versa.

16. The coin box detecting system of claim 14, wherein the indication circuit comprises a micro ampere meter and a second variable resistor; the second variable resistor comprises a first terminal, a second terminal, and an adjusting terminal; the first terminal of the second variable resistor is electrically connected to the output terminal of the second amplifier via the micro ampere meter; the second terminal of the second variable resistor is grounded; and the adjusting terminal of the second variable resistor is electrically connected to the second terminal of the second variable resistor.

17. The coin box detecting system of claim 9, wherein the resistance of the coin box decreases as a number of the coins put into the coin box increases.
